(19) United States
(12) Patent Application Publication
(10) Pub. No.: US 2012/0062502 A1
(43) Pub. Date: Mar. 15, 2012

(54) MODIFIED ELECTRODE PATTERN INTEGRATED TOUCH PANEL

(75) Inventors: SHR-LUNG CHEN, TAO-YUAN (TW); HSUEH-CHIH CHIANG, TAO-YUAN (TW); JYH-AN CHEN, TAO-YUAN (TW); SHIH-LIANG CHOU, TAO-YUAN (TW)

(73) Assignee: AVCT OPTICAL ELECTRONIC CO., LTD., TAO-YUAN (TW)

(21) Appl. No.: 12/880,271

(22) Filed: Sep. 13, 2010

(51) Int. Cl. G06F 3/045

(52) U.S. Cl. 345/174

(57) ABSTRACT

The present invention proposes a modified electrode pattern of integrated touch panel that can include two to four polygonal parallel rows of conductive segments disposed on a transparent conductive surface. Etched slots can also be formed in the structure to adjust its equivalent impedance. For instance, in the two polygonal parallel rows of electrode pattern, the first electrode row, located at the utmost outer periphery of the sensing layer, is made up of several segments of convex electrodes and the first spacing set each of them apart. The second electrode row is made up of several segments of crosswise electrodes located right at the centerline of the first spacing between the convex electrodes and on the convex portion of such electrodes. It is aimed to adjust the circuit impedance to the most optimum proportion so that its electric field distribution can be linearized; meanwhile, its corresponding width can be reduced.

### BACKGROUND OF THE INVENTION

1. Field of the Invention

The present invention is related to the touch panel technology, specifically in the invention of an integrated touch panel with modified electrode pattern so that the panel has a reduced width and distribute a linearizing electric field.

2. Description of the Related Art

With the advancement of technology, the application of touch panel is becoming more and more popular. There are some common types of touch panels based on their respective sensing principles; i.e. the resistive panel, capacitive panel, surface acoustic wave panel, optical (infrared) panel etc. Among these, the most commonly used in the market are the resistive panels and the capacitive panels.

The response process of touch panels that work on electric field distribution are generally depicted as follows: When a user touches the touch panel with a touch pen or fingers, electrical changes takes place, creating a coordinate signal so that the location of touch can be determined. Therefore, the electrode pattern design of a touch panel usually becomes one of the critical factors deciding if a touch panel can accurately determine the location of touch.

Take capacitive panel for example, by sensing the electric current around the induction spot and the interrelation of these currents, the touch location is determined. The arrangement of the electrode pattern, therefore, decides the electric field distribution in the touch panel. Generally speaking, the better the performance of the electric field lines created by the electrode pattern, the higher the accuracy rate of identifying the touch location by the touch panel. Other than that, the width of electrode pattern will affect the range of touch in a touch screen due to the fact that the electrode pattern is distributed at all peripheries of the touch panel. That is to say, the bigger the size of the electrode pattern, the smaller the size of the sensing areas in a touch panel. Therefore, although increasing the number of electrode rows enhances its performance, it, at the same time, shrinks the size of the sensing areas in the touch panel. The cost and labor time of manufacturing is also increased.

To overcome the drawback, some proposed that the electric field distribution may be improved with a combination of Z-shaped electrode, insulation areas, and alternate spacing. Alternatively, a long or T-shaped conductive now may be inserted within the spacing of the above structure. Others tried to use electrode pattern made up of segments of paralleled conductive rows and spacing. Or an insulation area is placed within the paralleled conductive structure to fulfill the above-mentioned purpose.

However, the structures mentioned above fail to achieve the purpose of stable electric distribution around the peripheries of the touch panel. Therefore, the vital goal of improvement for touch panel designer and manufacturer is to effectively control the electric field distribution and reduce the complexity of the electrode pattern and the overall width of the electrode pattern.

### SUMMARY OF THE INVENTION

In view of the abovementioned problems, the purpose of the present invention is to propose a touch panel structure of both lower cost and higher efficiency. By improving the performance of electric field created by the electrode pattern, the accuracy in identifying inductions is improved. Meanwhile, the width of the electrode pattern can be controlled so that the range of touch of the integrated touch panel is not affected.

To achieve the abovementioned purpose, the invention is to propose a modified electrode pattern of an integrated touch panel which consists of a substrate made of transparent and non-conductive material, a sensing layer formed on one side face of the substrate, and an electrode pattern placed around the periphery of the sensing layer. The electrode pattern consists of a first polygonal parallel row and a second polygonal parallel row. The first polygonal parallel row is placed at the utmost outer periphery of the sensing layer, opposite to the center part of the integrated touch panel. It is made up of several segments of convex electrodes and among each electrode there is the first spacing. The second polygonal parallel row consists of several segments of crosswise electrodes located right at the centerline of the first spacing between each of convex portions of the convex electrodes.

To manage the electric field distribution effectively, the electrode pattern comprises a plurality of etched slots which are located at about the center part of the integrated touch panel. And to improve the electric distribution lines, slot spacing is located between the etched slots. Besides, the slot spacing located adjacent to the four edges of the integrated touch panel are shorter than the spacing located farther away from the periphery of the four edges of integrated touch panel.

The beeline distance between each electrode of the two polygonal parallel rows next to each other is d, the stack length between each adjacent pair of electrodes of the polygonal parallel row equals to 1, and so the formed equivalent impendence value is R, which is in direct proportion to the sheet resistance (Rs) of the conductive film; that is, R∝Rs*d/l. By means of the design, we can effectively adjust the equivalent impendence of the electrode pattern and maintain the value at a fixed level. Meanwhile, we can also achieve the purpose of narrow side design without changing the circuit impedance since the width of the electrode pattern is less than 2.5 mm.

To achieve the abovementioned purpose, the invention also proposes another modified electrode pattern of integrated touch panel which consists of a substrate that is transparent and non-conductive, a sensing layer that is formed on one side face of the substrate, and an electrode pattern that is established around the peripheries of the sensing layer. The electrode pattern consists of a first polygonal parallel row, a second polygonal parallel row, and a third polygonal parallel row. The first row, located at the utmost outer periphery of the sensing layer, opposite to the center of the integrated touch panel, consists of several segments of convex electrodes and among each electrode there is the first spacing. The second row consists of several segments of convex electrodes which are located at the centerline of the first spacing and on the convex part of the individual convex electrode. The third row consists of several segments of crosswise electrodes and each of them is located on the convex part of the individual convex electrode of the second electrode row.

The beeline distance between each electrode of the two polygonal parallel rows next to each other is d, which is in inverse proportion to the length of the crossing part that equals to 1, and so the formed equivalent impendence value is R, which is in direct proportion to the sheet resistance (Rs) of the conductive film; that is, R∝Rs*d/l. By means of the design, we can effectively adjust the equivalent resistive value of the electrode pattern and maintain the value at a fixed level. Meanwhile, we can also achieve the purpose of narrow side design without changing the circuit impedance since the width of the electrode pattern is less than 2.5 mm.

To achieve the abovementioned purpose, the invention also proposes another modified electrode pattern of integrated touch panel which consists of a substrate that is transparent and non-conductive, a sensing layer that is formed on one side face of the substrate, and an electrode pattern that is established around the peripheries of the sensing layer. The electrode pattern consists of a first polygonal parallel row, a second polygonal parallel row, a third polygonal parallel row, and a fourth polygonal parallel row. The first row, located at the utmost outer periphery of the sensing layer, opposite to the center of the integrated touch panel consists of several segments of crosswise electrode and among each electrode there is the first spacing. The second row consists of several segments of crosswise electrodes and there is a second spacing between each electrode. The crosswise electrodes are located at the centerline of the first spacing and correspond to the center part of the integrated touch panel. The third row consists of several segments of crosswise electrodes and there is a third spacing between each electrode. Each of the crosswise electrodes is located at the centerline of the second spacing and corresponds to the center part of the integrated touch panel. The fourth row consists of several segments of crosswise electrodes and each of the crosswise electrodes is located at the centerline of the third spacing and corresponds to the center part of the integrated touch panel.

The beeline distance between each electrode of the two polygonal parallel rows next to each other is d, the stack length between each adjacent pair of electrodes of the polygonal parallel row equals to 1, and so the equivalent impedance value from thereon is R, which is in direct proportion to the sheet resistance (Rs) of the conductive film; that is, R∝Rs*d/l. By means of the design, we can effectively adjust the equivalent resistive value of the electrode pattern and maintain the value at a fixed level. Meanwhile, we can also achieve the purpose of narrow side design without changing the circuit impedance since the width of the electrode pattern is less than 2.5 mm.

To achieve the abovementioned purpose, the invention also proposes the other modified electrode pattern of integrated touch panel which consists of a substrate that is transparent and non-conductive, a sensing layer that is formed on one side face of the substrate, and an electrode pattern that is established around the periphery of the sensing layer. The electrode pattern consists of a first polygonal parallel row, a second polygonal parallel row, a third polygonal parallel row, and a fourth polygonal parallel row. The first row, located at the utmost outer periphery of the sensing layer, opposite to the center of the integrated touch panel, consists of several segments of crosswise electrodes and among each electrode there is a first spacing. The second row consists of several segments of crosswise electrodes and there is a second spacing between each electrode. The second crosswise electrodes are located at the centerline of the first spacing and correspond to the center part of the integrated touch panel. The third row consists of several segments of crosswise electrodes and there is a third spacing between each electrode. Each of the third crosswise electrodes is located at the centerline of the second spacing and corresponds to the center part of the integrated touch panel. The fourth row consists of several segments of crosswise electrodes and each of the crosswise electrodes is located on the convex part of the convex electrode of the third row.

The beeline distance between each electrode of the two polygonal parallel rows next to each other is d, the stack length between each adjacent row of electrodes equals to 1, and so the formed equivalent impedance value is R, which is in direct proportion to the sheet resistance (Rs) of the conductive film; that is, R∝Rs*d/l. By means of the design, we can effectively adjust the equivalent resistive value of the electrode pattern and maintain the value at a fixed level. Meanwhile, we can also achieve the purpose of narrow side design without changing the circuit impedance since the width of the electrode pattern is less than 2.5 mm.

The advantages of the invention is that different length of lines are used to stack different combination of electrode pattern and slots of different distances are etched to adjust the circuit impedance of the touch panel to the best proportion so that the electric field line distribution will become superior compared with that of the conventional pattern design. Moreover, the purpose of narrow side design can also be achieved without changing the circuit impedance since the corresponding width of the electrode pattern is narrowed to less than 2.5 mm.

### BRIEF DESCRIPTION OF THE DRAWINGS

FIG. 1 is an outlook schematic diagram of modified electrode pattern in the integrated touch panel in accordance with the present invention;

FIG. 2 is a partial schematic diagram of the electrode pattern made up of two conductive parallel rows in accordance with the present invention;

FIG. 3 is a partial schematic diagram of the electrode pattern made up of two conductive parallel rows with additional etched slots design in accordance with the present invention;

FIG. 4 is a partial schematic diagram of the electrode pattern made up of three conductive parallel rows in accordance with the present invention;

FIG. 5 is a partial schematic diagram of the electrode pattern made up of four conductive parallel rows in accordance with the present invention;

FIG. 6 is another partial schematic diagram of the electrode pattern made up of four conductive parallel rows in accordance with the present invention; and

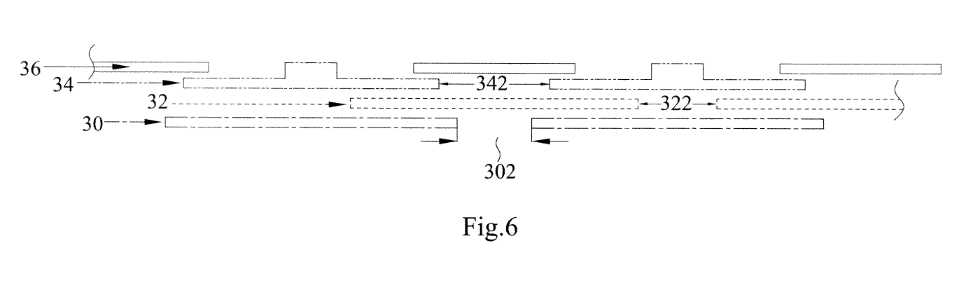

FIG. 7 is a schematic diagram of the circuit impedance in accordance with the present invention.

### DETAILED DESCRIPTION OF THE PREFERRED EMBODIMENTS

The descriptions of the drawings are given below so that the certification committee will have a clear idea of the subject matter of the present invention. Please refer to the drawings and their respective descriptions.

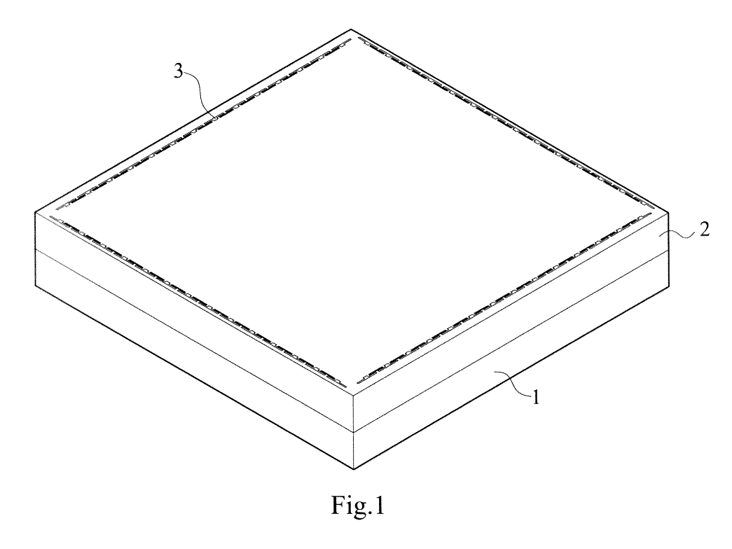

Please refer to the first drawing (FIG. 1) which presents the schematic diagram of the outlook of the integrated touch panel with modified electrode pattern. This integrated touch panel consists of a substrate 1, a sensing layer 2, and an electrode pattern 3. The substrate 1 is made of transparent and non-conductive material such as glass or polymer plastic. The sensing layer 2, located at one side surface of the substrate 1, is usually made of Indium-Tin-Oxide (ITO). And the electrode pattern 3 is then coated on the surface of the sensing layer 2 and along the periphery of the sensing layer 2 so that the performance of the electric field lines can be enhanced. Silver lines are commonly chosen as its material.

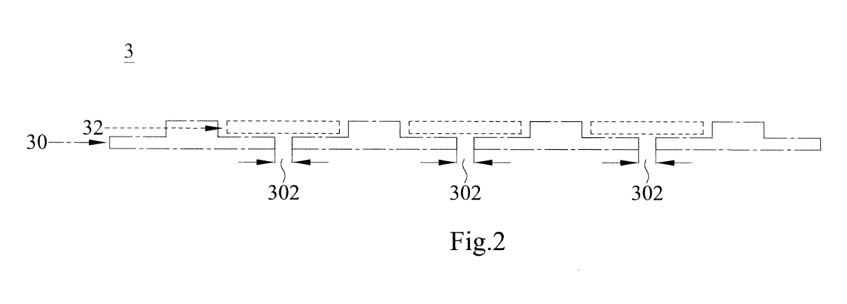

Please refer to the second drawing (FIG. 2), which presents the partial schematic diagram of the modified electrode pattern created by two conductive polygonal parallel rows in the present invention. It is the top view of the partial electrode pattern 3 structure in the first drawing. And the electrode pattern 3 consists of a first row 30 and a second row 32. The first row 30 is opposite to the center part of the integrated touch panel and so it is located at the utmost outer periphery of the sensing layer. It consists of a plurality of convex electrode arranged relative to each other, and there is a first spacing 302 formed between each of the convex electrodes. The second row 32 consists of a plurality of crosswise electrodes arranged relative each other, and the cross wise electrodes are located at the convex portion of the convex electrodes and the centerline of each of the first spacing 302. With such arrangement, the electrode pattern 3 originates from the combination structure of the first row 30 and the second row 32. Meanwhile, the length of each row in the electrode pattern 3 reduces gradually from outer part to the inner part. That means the length of each unit in the first row 30 is longer than that in the second row 32.

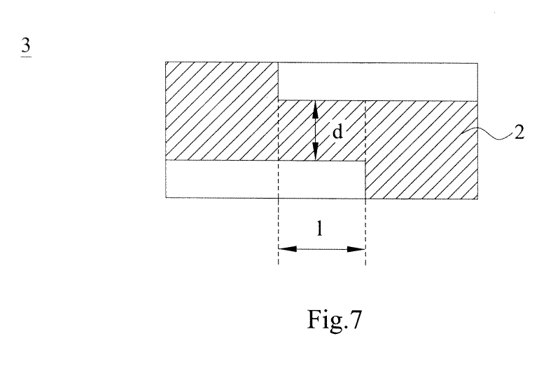

Please refer to the seventh drawing (FIG. 7) which is the schematic diagram of the circuit impedance of the present invention. The drawing shows a single electrode in the neighboring rows of electrode pattern 3. The beeline distance between each electrode of the two rows next to each other is d, the stack length between each adjacent pair of the electrodes of the row equals to 1, and so the formed equivalent impendence value is R, which is in direct proportion to the sheet resistance (Rs) of the conductive film; that is, R∝Rs*d/l. By means of the design, the equivalent resistive value of the electrode pattern 3 as well as the value of d and the value of 1 can be adjusted to maintain the level of resistive value. For instance, an equivalent electric resistive value is measured to be 15 ohms; the purpose of narrow side design can be achieved without changing the circuit impedance since d is in direct proportion to R, and l is in inverse proportion to R and what we need to do is to adjust the value of them. Therefore, the interrelation of those values can be used to achieve the purpose of narrow side design easily. In the present invention, the width of the electrode pattern 3 can be reduced to less than 2.5 mm.

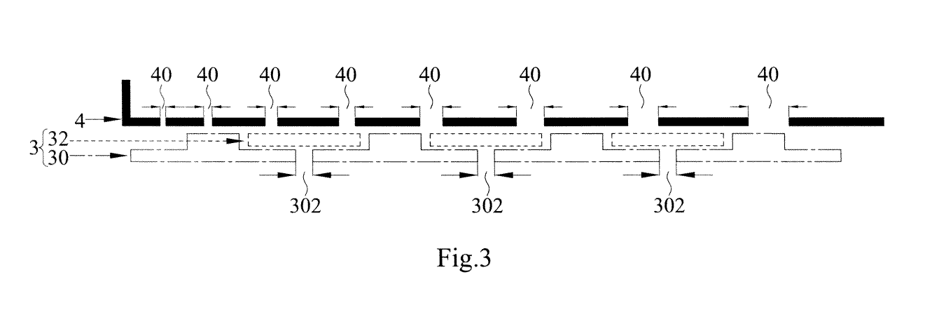

Please refer to the third drawing (FIG. 3) which indicates the partial schematic diagram of the electrode pattern with additional etched slots design and the pattern is made up of a two conductive polygonal parallel rows in the present invention. This electrode pattern 3 includes several segments of etched slots 4 which are located more inner around the center part of the integrated touch panel and the etched slots 4 are used to linearize the electric field lines. The line performance becomes better especially when the etched slots 4 are etched with unequal distances. For instance, the slot spacing 40 between each pair of etched slots 4 and the slot spacing 40 located near the periphery of the four sides of the integrated panel are shorter than the spacing located farther from the periphery of the four sides of integrated panel. By means of this design, we can improve greatly the inferior performance of the electric field lines in the periphery areas of the conventional designs.

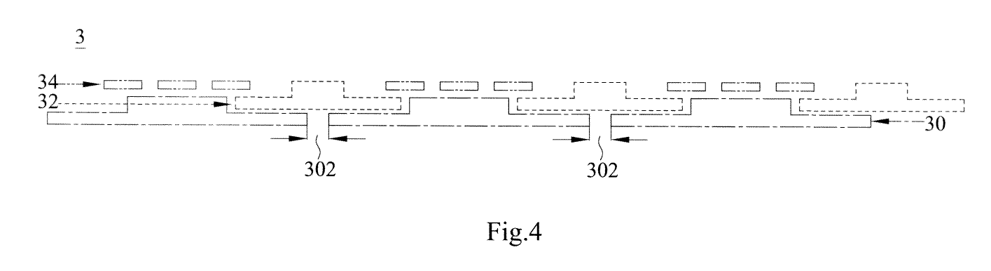

Please refer to the fourth drawing (FIG. 4) and the seventh drawing (FIG. 7) which indicate the partial schematic diagram of the electrode pattern comprised with three conductive polygonal parallel rows and the schematic diagram of a circuit impedance design of the present invention respectively. The embodiment of the present invention indicates the electrode pattern 3 made up of a three-row conductive line. The electrode pattern 3 consists of a first row 30, a second row 32, and a third row 34. The first row 30 is opposite to the center area of the integrated touch panel and so it is located at the utmost outer periphery of the sensing layer 2. It consists of several segments of convex electrode rows and there is a first spacing 302 between the electrodes. The second row 32 consists of several segments of convex electrodes which are located at the convex position of the convex electrodes located at the centerline of the first spacing 302 and corresponds to the first row 30 and near the center part of the integrated touch panel. And the third row 34, located at the convex portion of the convex electrodes of the second row 32, consists of several segments of crosswise electrodes. With such arrangement, the electrode pattern 3 originates from the combination structure of the first row 30, the second row 32, and the third row 34. Meanwhile, each row of the electrode pattern reduces gradually from outer part to the inner part, namely, that means the length of each unit in the first row 30 is longer than that in the second row 32, and the length of each unit in the second row 32 is longer than that in the third row 34.

Under the same circumstance, we can achieve the narrow side design without changing the circuit impedance by utilizing the interrelation that R is in direct proportion to the sheet resistance (Rs) of the conductive film, such that R∝Rs*d/l to adjust the proportion of the value of d and the value of 1. To make it short, we can achieve the purpose of narrow side width easily by using the interrelation. In this present invention the width of the electrode pattern 3 can therefore be reduced to less than 2.5 mm.

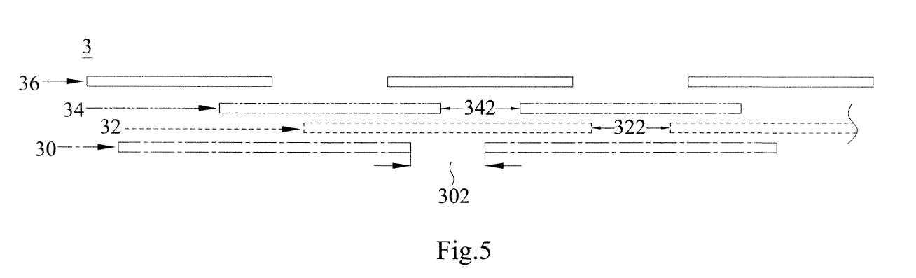

Please refer to the fifth drawing (FIG. 5) and the seventh drawing (FIG. 7) which indicate the partial schematic diagram of the electrode pattern comprised with four rows of conductive polygonal parallel lines and the schematic diagram of a circuit impedance design of this invention. The embodiment of the present invention indicates the electrode pattern 3 made up of four rows of conductive lines. The electrode pattern 3 consists of a first row 30, a second row 32, a third row 34, and a fourth row 36. The first row 30 is opposite to the center area of the integrated touch panel and so it is located at the utmost outer periphery of the sensing layer 2. It consists of several segments of crosswise electrodes and there is a first spacing 302 between the electrodes. The second row 32 consists of several segments of crosswise electrodes and there is a second spacing 322 between each of the crosswise electrodes. And the crosswise electrodes of the second row 32 are located at the centerline position of the first spacing 302 and correspond to the first row 30 close to the center part the integrated touch panel. The third row 34 consists a plurality of crosswise electrodes arranged relative to each other, and there is a third spacing 342 formed between each of the crosswise electrodes. And the crosswise electrodes of the third row 34 are located at the centerline position of the second spacing 322 and correspond to the second row 32 close to the center part the integrated touch panel. The fourth row 36 consists of a plurality of crosswise electrodes arranged relative to each other, and the crosswise electrodes of the fourth row 36 are located at the centerline position of the third spacing 342 and correspond to the third row 34 close to the center part the integrated touch panel. With such arrangement, the electrode pattern 3 of the present design originates from the combination of the first row 30, the second row 32, the third row 34, and the fourth row 36. Meanwhile, each row of the electrode pattern reduces gradually from outer part to the inner part, namely, the length of each unit in the first row 30 is longer than that in the second row 32, the length of each unit in the second row 32 is longer than that of the third row 34, and the length of each unit in the third row 34 is longer than that in the fourth row 36.

Under the same circumstance, the narrow side design can be achieved without changing the circuit impedance by utilizing the interrelation that R is in direct proportion to the sheet resistance (Rs) of the conductive film, so that R∝Rs*d/l to adjust the proportion of the value of d and the value of 1. To make it short, the purpose of narrow side width can be easily achieved by using the interrelation. In this present invention the width of the electrode pattern 3 can therefore be reduced to less than 2.5 mm.

Please refer to the sixth drawing (FIG. 5) and the seventh drawing (FIG. 7) which indicate the partial schematic diagram of the electrode pattern comprised with four rows of conductive polygonal parallel lines and the schematic diagram of a circuit impedance design of this invention respectively. The embodiment of the present invention indicates the electrode pattern 3 made up of four rows of conductive lines. The electrode pattern 3 consists of a first row 30, a second row 32, a third row 34, and a fourth row 36. But the detailed structure design of this pattern, different from that of the previous one, is depicted as follows: The first row 30 is opposite to the center area of the integrated touch panel and so it is located at the utmost outer periphery of the sensing layer 2. It consists of several segments of crosswise electrodes and there is a first spacing 302 between the electrodes. The second row 32 consists of several segments of crosswise electrodes and there is a second spacing 322 between the electrodes. And the crosswise electrodes of the second row 32 are located at the centerline position of the first spacing 302 and correspond to the first now 30 close to the center part the integrated touch panel. The third row 34 consists of several segments of convex electrodes and there is a third spacing 342 between the convex electrodes. And the convex electrodes of the third row 34 are located at the centerline position of the second spacing 322 and correspond to the second row 32 close to the center part the integrated touch panel. The fourth row 36 consists of several segments of crosswise electrodes and the crosswise electrodes of the fourth row 36 are located at the convex portion of the convex electrodes. Meanwhile, each row of the electrode pattern reduces gradually from outer part to the inner part, namely, the length of each unit in the first row 30 is longer than that in the second row 32, the length of each unit in the second row 32 is longer than that in the third row 34, and the length of each unit in the third row 34 is longer than that in the fourth row 36.

Under the same circumstance, the purpose of the narrow side design can be achieved without changing the circuit impedance by utilizing the interrelation that R is in direct proportion to the sheet resistance (Rs) of the conductive film, so that Roc Rs*d/l to adjust the proportion of the value of d and the value of 1. To make it short, the purpose of narrow side width can be easily achieved by using the interrelation. In this present invention the width of the electrode pattern 3 can therefore be reduced to less than 2.5 mm.

To summarize, with different combination of different length of stacking patterns and unequal distances of etched slots, the electrode patterns are created. By utilizing the interrelation that R is in direct proportion to the sheet resistance (Rs) of the conductive film, so that R∝Rs*d/l to adjust the circuit impedance to the best value proportionally, the purpose of narrow side design can be achieved without changing the circuit impedance, and what's even better, the width of the electrode pattern can be reduced to less than 2.5 mm. At the same time, the electric field line distribution of the integrated touch panel is also taken into the design consideration, and this is especially important for the stable electric field line performance at the periphery areas of the four sides of the touch panel, compared with the electric field distribution of conventional electrode pattern design.

All the above-mentioned are only applicable to the preferred embodiment of the present invention and will not restrict the scope of the actual embodiment of the present invention. As such, all equivalent or slightly modified versions produced by those familiar with the technology mentioned here will be considered the patent claim of the present invention in the event that such modification is found to be consistent with the essence and claims of the present invention.

What is claimed is:

1. A modified electrode pattern integrated touch panel, comprising:
a substrate, made of transparent and non-conductive material;
a sensing layer, formed on one side surface of the substrate; and
an electrode pattern, placed around the periphery of the sensing layer, and including:
a first conductive polygonal parallel row, disposed on the utmost outer periphery of the sensing layer corresponding to the center of the integrated touch panel, and assembled with a plurality of convex electrodes arranged relative to each other, and a plurality of first spacing formed between each of the convex electrodes; and
a second conductive polygonal parallel row, assembled with a plurality of crosswise electrodes arranged relative to each other, the crosswise electrodes located on centerline of each of the first spacing, and disposed between convex portion of each of the convex electrodes.

2. The modified electrode pattern integrated touch panel of claim 1, wherein the electrode pattern further comprises a plurality of etched slots disposed opposite to the electrode pattern and adjacent to center part of the integrated touch panel.

3. The modified electrode pattern integrated touch panel of claim 2, wherein a slot spacing is formed between each of the etched slots, and the slot spacing located adjacent to the four edges of the integrated touch panel is shorter than that of the slot spacing located far away from the four edges of the integrated touch panel.

4. The modified electrode pattern integrated touch panel of claim 1, wherein a beeline distance between each adjacent pair of electrodes of the row is d, a stack length between each adjacent pair of electrodes of the row is equal to 1, so as Co form a equivalent impendence value R in direct proportion to the sheet resistance (Rs) of the conductive film, thus R∝Rs*d/1, and the total width of the electrode pattern is less than 2.5 mm.

5. The modified electrode pattern integrated touch panel of claim 2 wherein a beeline distance between each adjacent pair of electrodes of the row is d, a stack length between each adjacent pair of electrodes of the row is equal to 1, so as to form a equivalent impedance value R in direct proportion to the sheet resistance (Rs) of the conductive film, thus R∝Rs*d/l, and the total width of the electrode pattern is less than 2.5 mm.

6. The modified electrode pattern integrated touch panel of claim 3, wherein a beeline distance between each adjacent pair of electrodes of the row is d, a stack length between each adjacent pair of electrodes of the row is equal to 1, so as to form a equivalent impedance value R in direct proportion to the sheet resistance (Rs) of the conductive film, thus R∝Rs*d/l, and the total width of the electrode pattern is less than 2.5 mm.

7. A modified electrode pattern integrated touch panel, comprising:
a substrate, made of transparent and non-conductive material;
a sensing layer, formed on one side surface of the substrate; and
an electrode pattern, placed around the periphery of the sensing layer, and including:
a first conductive polygonal parallel row placed at the utmost outer periphery of the sensing layer corresponding to center part of the integrated touch panel, and assembled with a plurality of convex electrodes arranged relative to each other, and a plurality of first spacing formed between each of the convex electrodes;
a second conductive polygonal parallel row, assembled with a plurality of convex electrodes arranged relative to each other, the convex electrodes located on centerline of each of the first spacing, opposite to the first row, and adjacent to center part of the integrated touch panel; and
a third conductive polygonal parallel row, assembled with a plurality of crosswise electrodes arranged relative to each other, and disposed between convex portion of each of the convex electrodes of the second row.

8. The modified electrode pattern integrated touch panel of claim 7, wherein a beeline distance between each adjacent pair of electrodes of the row is d, a stack length between each pair of adjacent electrodes of the artwork row is equal to 1, so as to form a equivalent impedance value R in direct proportion to the sheet resistance (Rs) of the conductive film, thus R∝Rs*d/l, and the total width of the electrode pattern is less than 2.5 mm.

9. A modified electrode pattern integrated touch panel, comprising:
a substrate, made of transparent and non-conductive material;
a sensing layer, formed on one side face of the substrate; and
an electrode pattern, placed around the periphery of the sensing layer and including:
a first conductive polygonal parallel row, placed at the utmost outer periphery of the sensing layer corresponding to center part of the integrated touch panel, and assembled with a plurality of crosswise electrodes arranged relative to each other, and a plurality of first spacing formed between each of the crosswise electrodes;
a second conductive polygonal parallel row, assembled with a plurality of crosswise electrodes arranged relative to each other, a plurality of second spacing formed between each of the crosswise electrodes, the crosswise electrodes of the second row located on centerline of each of the first spacing, opposite to the first row and adjacent to center part of the integrated touch panel;
a third row, assembled with a plurality of crosswise electrodes arranged relative to each other, a plurality of third spacing formed between each of the crosswise electrodes, the crosswise electrodes of the third row located on centerline of each of the second spacing, opposite to the second row and adjacent to center part of the integrated touch panel; and
a fourth conductive polygonal parallel row, assembled with a plurality of crosswise electrodes arranged relative to each other, the crosswise electrodes located on centerline of each of the third spacing, opposite to the third row, and adjacent to center part of the integrated touch panel.

10. The modified electrode pattern integrated touch panel of claim 9, wherein a beeline distance between each adjacent pair of electrodes of the row is d, a stack length between each adjacent pair of electrodes of the row is equal to 1, so as to form a equivalent impedance value R in direct proportion to the sheet resistance (Rs) of the conductive film, thus R∝Rs*d/l, and the total width of the electrode pattern is less than 2.5 mm.

11. A modified electrode pattern integrated touch panel, comprising:
a substrate, made of transparent and non-conductive material;
a sensing layer, formed on one side face of the substrate; and
an electrode pattern, placed around the periphery of the sensing layer, and including:
a first conductive polygonal parallel row, placed at the utmost outer periphery of the sensing layer corresponding to center part of the integrated touch panel, and assembled with a plurality of crosswise electrodes arranged relative to each other, and a plurality of a first spacing formed between each of the crosswise electrodes a second conductive polygonal parallel row, assembled with a plurality of crosswise electrodes arranged relative to each other, the crosswise electrodes formed a plurality of second spacing located between each of the crosswise electrodes, the crosswise electrodes of the second row located on centerline of each of the first spacing, opposite to the first row and adjacent to center part of the integrated touch panel; and
a third conductive polygonal parallel row, assembled with a plurality of convex electrodes arranged relative to each other, a plurality of third spacing formed between each of the crosswise electrodes, the convex electrodes of the third row located on centerline of each of the second spacing, opposite to the second row and adjacent to center part of the integrated touch panel; and
a fourth conductive polygonal parallel row, assembled with a plurality of crosswise electrodes arranged relative to each other, and disposed between convex portion of each of the convex electrodes of the third row.

12. The modified electrode pattern integrated touch panel of claim 11, wherein a beeline distance between each adjacent pair of electrodes of the row is d, a stack length between each adjacent pair of electrodes of the row is equal to 1, so as to form a equivalent impedance value R in direct proportion to the sheet resistance (Rs) of the conductive film, thus R∝Rs*d/l, and the total width of the electrode pattern is less than 2.5 mm.
